(19) United States
(12) Patent Application Publication
(10) Pub. No.: US 2024/0055587 A1
(43) Pub. Date: Feb. 15, 2024

(54) ZINC RECHARGEABLE BATTERY

(71) Applicant: Seoul National University R&DB Foundation, Seoul (KR)

(72) Inventors: Jang Wook CHOI, Seoul (KR); Minkwan KIM, Seoul (KR); Jimin LEE, Seoul (KR)

(21) Appl. No.: 18/229,918

(22) Filed: Aug. 3, 2023

(30) Foreign Application Priority Data
Aug. 4, 2022 (KR) 10-2022-0097503

(51) Int. Cl. H01M 4/42; H01M 4/52; H01M 4/50; H01M 50/46

(52) U.S. Cl. CPC H01M 4/42; H01M 4/52; H01M 4/50; H01M 50/46; H01M 2004/027

(57) ABSTRACT

Disclosed is a zinc rechargeable battery, the zinc rechargeable battery including a positive electrode, a zinc-containing negative electrode, a separator between the positive electrode and the negative electrode, and an electrolyte, wherein the zinc rechargeable battery includes an additive and the additive is a compound having a donor number of about 32 or more.

### CROSS-REFERENCE TO RELATED APPLICATION

This application claims priority to and the benefit of Korean Patent Application No. 10-2022-0097503 filed in the Korean Intellectual Property Office on Aug. 4, 2022, the entire contents of which are incorporated herein by reference.

### BACKGROUND OF THE INVENTION

### (a) Field of the Invention

A zinc rechargeable battery is disclosed.

### (b) Description of the Related Art

Recently, demand for rechargeable batteries for being applied to the next generation energy storage systems, electric vehicles, etc. is increasing. Such rechargeable batteries are required to realize high electric power density and high safety. In this regard, aqueous rechargeable batteries are attracting lots of attentions as promising battery systems. First, the aqueous rechargeable batteries have a low risk of fire, unlike conventional organic electrolytes. Existing organic electrolytes are known to deteriorate the results by acting as a fuel for a fire when a battery is short-circuited due to physical, electrical, or chemical factors. However, the aqueous electrolyte does not act as a fuel for fire, and thus it can mitigate the risk of battery explosion or fire. Second, since water has a high ionic conductivity that is twice as high as that of general organic solvents, a rechargeable battery to which an aqueous electrolyte is applied can realize excellent high-rate rate capability.

Among aqueous rechargeable batteries, an aqueous zinc ion battery (AZIB) is in the spotlight. An aqueous zinc ion battery is generally composed of a zinc metal negative electrode, an inorganic/organic positive electrode, a weakly acidic aqueous electrolyte, and a separator. Zinc is readily available, relatively inexpensive, chemically stable in aqueous solvents, and non-toxic. In addition, the zinc is oxidized into Zn²⁺ without forming an intermediate phase under a weakly acidic condition, exhibits a high overpotential in a hydrogen evolution reaction (HER), has a redox potential of about −0.76 V vs. SHE suitable for the battery operation, and may realize high theoretical capacity (about 820 mAh/g, about 5854 mAh/L, a metal state).

However, aqueous zinc ion batteries have problems that, first, the zinc metal of the negative electrode is corroded or a water decomposition reaction (hydrogen generation reaction) occurs due to a side reaction of water, and secondly, zinc dendrites grow on the surface of the negative electrode according to repeated charging and discharging, resulting in a short circuit of the battery or a decrease in available zinc capacity and a rapid decrease in battery performance.

### SUMMARY OF THE INVENTION

The present invention is to suppress the side reaction of an electrolyte in the aqueous zinc ion batteries and also, suppress the dendrite growth on the surface of the zinc metal negative electrode to lead to uniform electrodeposition and stripping of the zinc and resultantly, improve reversibility of the zinc metal negative electrode, reduce irreversible capacity of the batteries, improve cycle-life characteristics and rate capability, and secure a low cost and fire stability.

In an embodiment, a zinc rechargeable battery includes a positive electrode, a zinc-containing negative electrode, a separator between the positive electrode and the negative electrode, and an electrolyte, wherein the zinc rechargeable battery includes an additive, and the additive is a compound having a donor number of about 32 or more.

In the zinc rechargeable battery according to an embodiment, side reactions of the electrolyte are suppressed and the surface of the zinc negative electrode is modified to suppress a growth of zinc dendrites, thereby improving the reversibility of the zinc negative electrode, realizing high capacity while improving cycle-life characteristics and rate capability, and ensuring safety.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a scanning electron microscope (SEM) image of the surface of the negative electrode electrodeposited after two galvanostatic charge/discharge cycles of a battery cell of Comparative Example 2.

FIG. 2 is a SEM image of the surface of the negative electrode electrodeposited after two galvanostatic charge/discharge cycles of the battery cell of Comparative Example 3.

FIG. 3 is a SEM image of the surface of the negative electrode electrodeposited after two galvanostatic charge/discharge cycles of the battery cell of Comparative Example 4.

FIG. 4 is a SEM image of the surface of the negative electrode electrodeposited after two galvanostatic charge/discharge cycles of the battery cell of Comparative Example 5.

FIG. 5 is a SEM image of the surface of the negative electrode electrodeposited after two galvanostatic charge/discharge cycles of the battery cell of Comparative Example 6-1.

FIG. 6 is a SEM image of the surface of the negative electrode electrodeposited after two galvanostatic charge/discharge cycles of the battery cell of Comparative Example 7.

FIG. 7 is a SEM image of the surface of the negative electrode electrodeposited after two galvanostatic charge/discharge cycles of the battery cell of Example 1.

FIG. 8 is a SEM image of the surface of the negative electrode electrodeposited after two galvanostatic charge/discharge cycles of the battery cell of Example 2.

FIG. 9 is a SEM image of the surface of the negative electrode electrodeposited after two galvanostatic charge/discharge cycles of the battery cell of Example 3-2.

FIG. 10 is a SEM image of the surface of the negative electrode electrodeposited after two galvanostatic charge/discharge cycles of the battery cell of Example 4.

FIG. 11 is a SEM image of a cross-section of the negative electrode electrodeposited after two galvanostatic charge/discharge cycles of the battery cell of Example 3-2.

FIG. 12 is a SEM image of the surface of the negative electrode of the battery cell of Example 3-2 after 3 cycles.

FIG. 13 is a SEM image of a cross-section of a negative electrode of the battery cell of Example 3-2 after 3 cycles.

FIG. 14 is a graph of current density versus voltage through linear sweep voltammetry (LSV) for cells including the electrolytes of Comparative Example 1 and Example 3-2.

FIG. 15 is a galvanostatic charge-discharge (GCD) analysis graph in the second cycle for symmetric cells of Comparative Example 1, Example 3-1, Example 3-2, and Example 3-3.

FIG. 16 shows electrochemical impedance spectroscopy (EIS) results of symmetrical cells of Comparative Example 1, Example 3-1, Example 3-2, and Example 3-3.

FIG. 17 shows, in order from the top, the transmittance after impregnating zinc powder into the electrolyte of Example 3-2 for 120 hours, the transmittance before impregnating zinc powder into the electrolyte of Example 3-2, the transmittance after impregnating the zinc powder in the electrolyte of Comparative Example 1 for 120 hours, and the transmittance before impregnating the zinc powder in the electrolyte of Comparative Example 1.

FIG. 18 is cycle-life characteristic evaluation graphs for symmetric cells of Comparative Example 1 and Example 3-2.

FIG. 19 is cycle-life characteristic evaluation graphs for full cells of Comparative Example 1 and Example 3-2.

FIG. 20 is a graph evaluating irreversible capacities generated during non-operation of the full cells of Comparative Example 1 and Example 3-2.

FIG. 21 is cycle-life characteristic evaluation graphs for full cells of Example 3-2, Comparative Example 6-1, and Comparative Example 6-2.

### DETAILED DESCRIPTION OF THE EMBODIMENTS

Hereinafter, specific embodiments will be described in detail so that those skilled in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

“Layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and the like.

As used herein, when specific definition is not otherwise provided, “substituted” refers to replacement of at least one hydrogen atom by a substituent selected from a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

In an embodiment, a zinc rechargeable battery includes a positive electrode, a zinc-containing negative electrode, a separator between the positive electrode and the negative electrode, and an electrolyte, wherein the zinc rechargeable battery includes an additive and the additive is a compound having a donor number of about 32 or more.

### Additives

The additive may be present on the surface of the negative electrode and/or within the electrolyte. Specifically, the additive may be present on the surface of the negative electrode in the form of a continuous film or may be present on the surface of the negative electrode in the form of an island, and may be adsorbed on zinc metal of the negative electrode. Alternatively, the additive may be dispersed in the electrolyte and may be present on both the surface of the electrolyte and the negative electrode.

The additive includes a compound having a donor number of about 32 or more. The donor number (DN) is a type of quantitative measure of Lewis basicity and is defined as the absolute value of the enthalpy value of the reaction between the standard Lewis acid SbCl₅ and the Lewis base to be measured in a dilute solution of 1,2-dichloroethane, a non-coordinating solvent with a donor number of 0, and the unit is kcal/mol. As a method for obtaining the number of donors, a method using 31P-NMR spectroscopic analysis by Viktor Gutmann can be used, and as a specific method, Coordination Chemistry Review 18 (1976) 225-255 “Solvent Effects on the Reactivities of Organometallic Compound” may be referred.

In an embodiment, the compound having the donor number of 32 or more may be adsorbed on the surface of the zinc-containing negative electrode, thereby modifying the surface of the negative electrode, that is, the interface between the negative electrode and the electrolyte. Accordingly, the decomposition reaction or side reaction of the electrolyte (e.g., water) is suppressed at the interface of the negative electrode, a growth of zinc dendrite (dendritic phase) is suppressed on the surface of the negative electrode, and uniform electrodeposition and stripping of zinc on the surface of the negative electrode may be induced. That is, when the compound having the donor number of 32 or more is used as an additive, problems occurring at the interface of the zinc negative electrode are solved, and battery performance, such as reducing irreversible capacity and improving cycle-life characteristics of zinc rechargeable batteries, can be dramatically improved.

The type of the compound having a donor number of 32 or more is not limited as long as it satisfies the donor number. For example, the compound having a donor number of 32 or more may include an element containing an unshared electron pair and may also include a hydrophobic functional group. The compound having a donor number of 32 or more may have a high donor number due to an increase in Lewis basicity of an element having an unshared electron pair by a hydrophobic functional group in the molecule.

The element containing an unshared electron pair may be, for example, N, O, P, S, or a combination thereof. The hydrophobic functional group is not particularly limited, but includes, for example, a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, or a combination thereof. Herein, the definition of substitution in ‘substituted or unsubstituted’ is the same as the definition of the term “substituted”.

The alkyl group having 1 to 20 carbon atoms may be, for example, an alkyl group having 1 to 15 carbon atoms, an alkyl group having 1 to 10 carbon atoms, an alkyl group having 1 to 8 carbon atoms, an alkyl group having 1 to 6 carbon atoms, an alkyl group having 1 to 5 carbon atoms, or an alkyl group having 1 to 3 carbon atoms. The cycloalkyl group having 3 to 20 carbon atoms may be, for example, a cycloalkyl group having 3 to 15 carbon atoms, a cycloalkyl group having 3 to 10 carbon atoms, or a cycloalkyl group having 3 to 6 carbon atoms. The aryl group having 3 to 20 carbon atoms may be, for example, an aryl group having 3 to 18 carbon atoms, an aryl group having 3 to 15 carbon atoms, an aryl group having 3 to carbon atoms, or an aryl group having 3 to 6 carbon atoms.

The donor number of the compound having the donor number of about 32 or more may be, for example, about 32 to about 80, about 32 to about 60, about 32 to about 50, or about 32 to about 45. Also, the compound having a donor number of about 32 or more may have, for example, a donor number of about 37 or more. A compound having a donor number of about 37 or more has excellent adsorption performance to a zinc negative electrode, and thus, even a small amount of the compound can induce zinc to be highly uniformly electrodeposited and stripped on the surface of the negative electrode, thereby improving the performance of a zinc rechargeable battery. According to one example, when the compound having a donor number of about 37 or more is used as an additive, zinc may be electrodeposited in a hexagonal column shape on the surface of the negative electrode, thereby inhibiting zinc dendrite growth, reducing irreversible capacity, and dramatically improving cycle-life characteristics.

The type of compound having a donor number of about 32 or more is not particularly limited, but examples include substituted or unsubstituted pyridine, branched chain alcohol, substituted or unsubstituted phosphoramide or a derivative thereof, a substituted or unsubstituted thiophosphoramide, a derivative thereof, or a combination thereof. They can improve battery performance by modifying the surface of a zinc negative electrode even in a small amount without adversely affecting the zinc rechargeable battery.

The branched chain alcohol may be, for example, a branched chain alcohol having 3 to 30 carbon atoms, a branched chain alcohol having 3 to 20 carbon atoms, or a branched chain alcohol having 3 to 10 carbon atoms.

The phosphoramide may be a compound in which P is substituted with three amine groups while having a P═O bond, and the derivative of phosphoramide may be a compound in which P is substituted with one or two amine groups while having a P═O bond. The thiophosphoramide refers to a compound in which P is substituted with three amine groups while having a P═S bond, and the derivative of thiophosphoramide refers to a compound in which P is substituted with one or two amine groups while having a P═S bond.

The compound having a donor number of about 32 or more may be, for example, at least one of the compounds represented by Chemical Formulas 1 to 3.

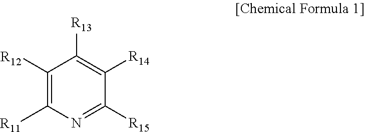

In Chemical Formula 1, R₁₁ to R₁₅ are the same or different, and are each independently hydrogen, a halogen element, a substituted or unsubstituted alkyl group having 1 to 20 carbon atoms, a substituted or unsubstituted cycloalkyl group having 3 to 20 carbon atoms, and a substituted or unsubstituted carbon atom. an aryl group having 3 to 20 carbon atoms, or a combination thereof.

For example, in Chemical Formula 1, R₁₁ to R₁₅ may be hydrogen or a substituted or unsubstituted alkyl group having 1 to 20 carbon atoms and the alkyl group having 1 to 20 carbon atoms may be for example an alkyl group having 1 to 10 carbon atoms, an alkyl group having 1 to 6 carbon atoms, or an alkyl group having 1 to 3 carbon atoms.

The compound represented by Chemical Formula 1 may be, for example, pyridine or alkyl-substituted pyridine. In the alkyl-substituted pyridine, the alkyl may be, for example, an alkyl having 1 to 10 carbon atoms, an alkyl having 1 to 5 carbon atoms, or an alkyl having 1 to 3 carbon atoms. For example, the compound represented by Chemical Formula 1 may be pyridine, methyl pyridine (2-methyl pyridine, 3-methyl pyridine, or 4-methyl pyridine), ethyl pyridine (2-ethyl pyridine, 3-ethyl pyridine, or 4-ethyl pyridine), 2,6-dimethyl pyridine, 4-bromomethyl pyridine, bromopyridine, and the like.

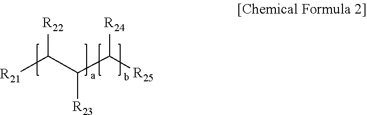

In Chemical Formula 2, R₂₃ is a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, a hydroxy group (—OH), or a combination thereof, R₂₁, R₂₂, R₂₄, and R₂₅ may be the same or different, and may each independently be hydrogen, a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, a hydroxy group, or a combination thereof, at least one of R₂₁ to R₂₅ is a hydroxy group, and a and b represent the number of repetitions of each unit and are integers from 1 to 10.

The compound represented by Chemical Formula 2 may be referred to as a branched chain alcohol.

In Chemical Formula 2, for example, R₂₃ may be a substituted or unsubstituted alkyl group having 1 to 20 carbon atoms, or a hydroxy group (—OH), R₂₁, R₂₂, R₂₄, and R₂₅ may independently be hydrogen, a substituted or unsubstituted alkyl group having 1 to 20 carbon atoms, or a hydroxy group, and In this case, the compound represented by Chemical Formula 2 may be referred to as a branched-chain aliphatic alcohol, for example, a branched-chain aliphatic alcohol having 4 to carbon atoms.

The compound represented by Chemical Formula 2 may be, for example, 2-methyl-1-propanol, 2-methyl-2-propanol, 2-methyl-2-butanol, 3-methyl-1-butanol, and the like.

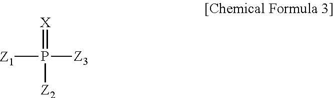

In Chemical Formula 3, X is O or S; Z₁ is NR₃₁R₃₂, OR₃₃, or Cl; Z₂ is NR₃₄R₃₅, OR₃₆, or Cl; Z₃ is NR₃₇R₃₈, OR₃₉, or Cl; at least one of Z₁, Z₂, and Z₃ is an amine group; and R₃₁ to R₃₉ are each independently hydrogen, a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, or a combination thereof.

The compound represented by Chemical Formula 3 has a structure in which 1 to 3 amine groups are substituted at Z₁ to Z₃ positions, and may be expressed as phosphoramide or a derivative thereof, or thiophosphoramide or a derivative thereof.

As a specific example, the compound represented by Chemical Formula 3 may be represented by Chemical Formula 3-1. The compound represented by Chemical Formula 3-1 may be referred to as phosphoramide, thiophosphoramide, or a derivative thereof having at least one amine group.

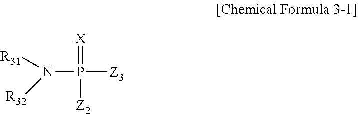

In Chemical Formula 3-1, Z₂ is NR₃₄R₃₆, OR₃₆, or Cl, Z₃ is NR₃₇R₃₈, OR₃₉, or Cl, and R₃₁, R₃₂, and R₃₄ to R₃₉ are each independently hydrogen, a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, or a combination thereof.

The compound represented by Chemical Formula 3 may be specifically represented by Chemical Formula 3-2. The compound represented by Chemical Formula 3-2 may be referred to as phosphoramide having two or more amine groups, thiophosphoramide, or a derivative thereof.

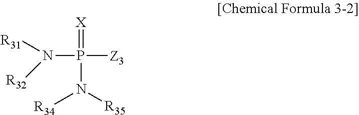

In Chemical Formula 3-2, Z₃ is NR₃₇R₃₈, OR₃₉, or Cl, R₃₁, R₃₂, R₃₄, R₃₅, and R₃₇ to R₃₉ are each independently hydrogen, a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, or a combination thereof.

The compound represented by Chemical Formula 3 may be specifically represented by Chemical Formula 3-3. The compound represented by Chemical Formula 3-3 may be referred to as phosphoramide or thiophosphoramide having three amine groups.

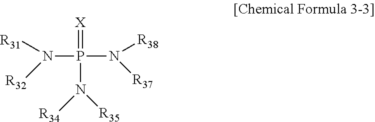

In Chemical Formula 3-3, R₃₁, R₃₂, R₃₄, R₃₅, R₃₇, and R₃₈ are each independently hydrogen, a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, or a combination thereof.

In Chemical Formula 3-3, R³¹ and R³², R³⁴ and R³⁵, and R³⁷ and R³⁸ may be linked to each other to form a ring.

In Chemical Formula 3-3, for example, R₃₁, R₃₂, R₃₄, R₃₅, R₃₇, and R₃₈ may each be hydrogen or a substituted or unsubstituted alkyl group having 1 to 20 carbon atoms, and at least one of R₃₁, R₃₂, R₃₄, R₃₅, R₃₇, and R₃₈ may be a substituted or unsubstituted alkyl group having 1 to 20 carbon atoms. In this case, the compound represented by Chemical Formula 3-3 may be an alkyl-substituted phosphoramide or an alkyl-substituted thiophosphoramide. The alkyl group having 1 to 20 carbon atoms may be, for example, an alkyl group having 1 to 10 carbon atoms, an alkyl group having 1 to 5 carbon atoms, or an alkyl group having 1 to 3 carbon atoms.

For example, in Chemical Formula 3-3, R₃₁, R₃₂, R₃₄, R₃₅, R₃₇, and R₃₈ may each independently be a substituted or unsubstituted alkyl group having 1 to 5 carbon atoms. In this case, the compound represented by Chemical Formula 3-3 is hexaalkyl phosphoramide, or a hexaalkyl thiophosphoramide. In this case, R₃₁, R₃₂, R₃₄, R₃₅, R₃₇, and R₃₈ may be for example the same as each other.

The compound represented by Chemical Formula 3 has a structure in which 1 to 3 amine groups are substituted. Examples of compounds having one amine group in Chemical Formula 3 may include N,N-dimethyl phosphoramide dichloride, N,N-diethyl phosphoramide dichloride, diethyl phosphoramidate, dimethyl N-(dimethyl) phosphoramidate, N, N-dimethyl 0,0′-diethyl phosphoramidate, dimethylphosphoramidothioic dichloride, O-methyl methylamidochloridothiophosphate, and the like.

The compounds having two amine groups in Chemical Formula 3 may include bis(dimethylamino)phosphinic chloride, bis(diethylamino)phosphinic chloride, bis(N, N-diethyl)-O-ethyl phosphorodiamidate, and bis(dimethylamino)chlorophosphine sulfide.

The compounds having three amine groups in Chemical Formula 3 may include pentamethyl phosphoramide, hexamethyl phosphoramide, hexaethyl phosphoramide, hexapropyl phosphoramide, triethylene phosphoramide, tris(N, N-tetramethylene) phosphoramide, 1,3,2-dimacaphosphoridin-2-amine, and the like.

The additive may be included in an amount of about 0.1 volume % to about 60 volume %, for example, about 0.1 volume % to about 50 volume %, about 0.1 volume % to about 40 volume %, about 0.1 volume % to about 30 volume %, about 1 volume % to about 20 volume %, about 1 volume % to about 15 volume %, about 1 volume % to about 12 volume %, about 1 volume % to about 10 volume %, about 1 volume % to about 8 volume %, about 1 volume % to about 5 volume %, about 2 volume % to about 60 volume %, or about 5 volume % to about 60 volume %, and the like, based on 100 volume % of a total amount of the electrolyte and additives. When the content of the additive is as described above, zinc is adsorbed on the surface of the negative electrode without adversely affecting the rechargeable battery, and problems occurring at the interface between the negative electrode and the electrolyte can be solved. For example, side reactions of an electrolyte such as water may be suppressed, zinc dendrite growth may be suppressed, and zinc may be uniformly electrodeposited/stripped, thereby improving the performance of a zinc rechargeable battery. Even a small amount of the additive may improve battery performance by modifying the surface of the zinc negative electrode.

### Negative Electrode

The negative electrode according an embodiment may include a zinc-containing material, for example, a zinc metal or a zinc alloy. Herein, the alloy may include at least one element selected from Ag, Al, Au, B, Ba, Ca, Ce, Co, Cr, Cu, F, Fe, Hg, In, Mg, Mn, Ni, P, S, Si, Sn, Sr, Ti, V, W, and Zr in addition to the zinc. The negative electrode may be in a form of a metal foil or a powder coated form, and may be, for example, a zinc metal foil, zinc powder, or zinc-containing conductive powder. The zinc-containing conductive powder may be powder including a carbon material, a silicon-based material, or a combination thereof in addition to the zinc.

The negative electrode may be manufactured by preparing the zinc-containing metal foil or by mixing the zinc powder or the zinc-containing conductive powder with a binder and a solvent and then, applying and drying the mixture on a current collector.

### Positive Electrode

In an embodiment, the positive electrode may be any positive electrode used in a zinc rechargeable battery without a particular limit. For example, the positive electrode may include a current collector and a positive electrode active material layer on the current collector, wherein the positive electrode active material layer may include a positive electrode active material and optionally, a binder and/or a conductive material.

The positive electrode active material may be, for example, an inorganic positive electrode active material, an organic positive electrode active material, or a combination thereof. The inorganic positive electrode active material may include a metal oxide, wherein a metal may be at least one selected Co, Ni, Mn, V, and Zn. The metal oxide may further include at least one element selected from Ag, Bi, Ca, Cu, Fe, K, Li, Na, Si, Sn, Ti, and Y. For example, the positive electrode active material may include a vanadium-containing positive electrode active material, for example, a vanadium oxide, for example, V₆O₁₃ having a three-dimensional crystal structure.

The organic positive electrode active material may be a compound which is made of carbon and hydrogen and optionally, includes an element such as oxygen, nitrogen, sulfur, halogen, etc. and a redox active organic material (ROMs). The organic positive electrode active material may be, for example, a phenazine-based compound, a phenothiazine-based compound, a phenoxazine-based compound, and the like but is not limited thereto. The organic positive electrode active material may be, for example, dimethylphenazine (DMPZ), triangular phenanthrenequinone-based macrocycle (PQ delta), dibenzo[b,i]thianthrene-5,7,12,14-tetraone (DTT), cailx[4]quinone (C4Q), phenanthrenequinone macrocyclic trimer (PQ-MCT), diquinoxalino[2,3-a:2′,3′-c]phenazine (HATN), 1,4-bis(diphenylamino)benzene (BDB), P-chloranil, pyrene-4,5,9,10-tetraone (PTO), 3,4,9,10-perylenetetracarboxylic dianhydride (Pi-PMC), and the like.

The positive electrode active material may be included in an amount of about 50 wt % to about 100 wt % based on 100 wt % of the positive electrode active material layer, for example, about 50 wt % to about 99.8 wt %, about 60 wt % to about 98 wt %, or about 70 wt % to about 95 wt %. Within the ranges, excellent processability may be maintained without deteriorating capacity.

The binder may be, for example, polyvinylidene fluoride, polyvinyl alcohol, carboxylmethyl cellulose, starch, hydroxypropyl cellulose, regenerated cellulose, polyvinylpyrrolidone, tetrafluoroethylene, polyethylene, polypropylene, ethylene-propylene-diene polymer (EPDM), sulfonated EPDM, a styrene butadiene rubber, a fluorine rubber, and the like. The binder may be included in an amount of about 0.1 wt % to about 20 wt %, about 0.1 wt % to about 15 wt %, or about 1 to about 10 wt % based on 100 wt % of the positive electrode active material layer, and within the content ranges, an appropriate binding force may be achieved without deteriorating capacity.

Examples of the conductive material may include a carbon-based material such as natural graphite, artificial graphite, carbon black, acetylene black, ketjen black, carbon fiber, carbon nanofiber, and carbon nanotube; a metal-based material containing copper, nickel, aluminum, silver, etc., in the form of a metal powder or a metal fiber; a conductive polymer such as a polyphenylene derivative; or a combination thereof. The conductive agent may be included in an amount of about 0.1 wt % to about 30 wt %, about 0.1 wt % to about 25 wt %, or about 1 wt % to about 20 wt % based on 100 wt % of the positive electrode active material layer, and within the content ranges, appropriate electron conductivity may be realized without deteriorating capacity.

The positive electrode current collector is not particularly limited but may include, for example, stainless steel, aluminum, nickel, titanium, pyrolytic graphite, or the aluminum or stainless steel surface-treated with carbon, nickel, titanium, silver, and the like and have a thickness of about 3 μm to about 100 μm. On the surface of the positive electrode current collector, fine concavo-convex may be formed to increase adherence of the positive electrode active material, which may have various forms of a film, a sheet, a foil, a net, a porous body, a foam, a non-woven fabric, and the like.

### Separator

The separator is to separate the positive and negative electrodes and provide a passage for zinc ions to move and may be any separator generally used in a zinc rechargeable battery without particular limitation. The separator may have low resistance to movement of zinc ions but excellent impregnation ability for an electrolyte. For example, the separator may include glass fiber, polyester, polyethylene, polypropylene, polytetrafluoroethylene, or a combination thereof, and may be in the form of a nonwoven fabric or fabric. The separator may have a thickness of about 5 to about 300 μm. The separator may have a single-layer or multi-layer structure, and may be coated with a ceramic component or a polymer material to secure heat resistance and mechanical strength.

### Electrolyte

The electrolyte may be a conventional organic electrolyte used in a zinc rechargeable battery, an aqueous electrolyte, or a combination thereof. The electrolyte according to an embodiment may be an aqueous electrolyte or a mixture of aqueous and organic electrolytes. The aqueous electrolyte may include an aqueous solvent, and the aqueous solvent may include water, an alcohol-based solvent, or a combination thereof, and may include, for example, distilled water or deionized water. The aqueous electrolyte may exhibit about 100 times to about 1000 times higher ionic conductivity than a conventional organic electrolyte and thus significantly increase a movement speed of zinc ions, thereby improving rate characteristics of a battery and dramatically increasing a charging rate. In addition, the aqueous electrolyte, unlike the conventional organic electrolyte, may have a low risk of explosion and fire, thereby securing battery safety. When using an aqueous electrolyte, a zinc rechargeable battery according to an embodiment may be referred to as an aqueous zinc rechargeable battery.

The organic electrolyte may include an organic solvent. The organic solvent may also be referred to as a non-aqueous organic solvent, and may include for example nitrile solvents such as acetonitrile, propionitrile, and butyronitrile; carbonate solvents such as dimethyl carbonate, diethyl carbonate, dipropyl carbonate, methylethyl carbonate, methylpropyl carbonate, ethylpropyl carbonate, ethylene carbonate, propylene carbonate, and butylene carbonate; ketone solvents such as acetone and cyclohexanone; alcohol solvents such as methanol, ethanol, propanol, and isopropanol; amide solvents such as N,N-dimethylformamide and N,N-dimethylacetamide; carbamate solvents such as 3-methyl-2-oxazolidone; and sulfur-containing compound-based solvents such as sulfolane, dimethyl sulfoxide, and 1,3-propanesultone.

The aqueous and organic mixed electrolytes include both an aqueous solvent and an organic solvent, and a mixing ratio of the aqueous solvent and the organic solvent may be appropriately adjusted according to the configuration of the battery to be used.

The electrolyte may include a zinc salt, and the zinc salt may include, for example, ZnSO₄, Zn(NO₃)₂, Zn(CH₃CO₂)₂, ZnCl₂, ZnBr₂, Zn[N(CF₃SO₂)₂]₂, Zn[N(C₂F₅SO₂)₂]₂, Zn[N(C₂F₅SO₂)(CF₃SO₂)]₂, Zn(CF₃SO₃)₂, Zn(C₂F₅SO₃)₂, a hydrate thereof, or a combination thereof.

A concentration of the zinc salt may be about 0.1 m to about 30 m, about 0.1 m to about 20 m, about 0.1 m to about 10 m, or about 0.2 m to about 5 m, or about 0.5 m to about 3 m based on the electrolyte. When the electrolyte includes the zinc salt in the concentration range described above, the zinc rechargeable battery may realize high efficiency and cycle-life characteristics.

A zinc rechargeable battery according to an embodiment may be cylindrical, prismatic, thin film, or the like, and may be, for example, a large thin film type. Since the zinc rechargeable battery realizes high capacity, excellent rate capability, and excellent cycle-life characteristics, it can be applied to various energy storage systems, notebook computers, mobile devices, portable electronic devices, and electric vehicles.

### EXAMPLES

Hereinafter, examples of the present invention and comparative examples are described. It is to be understood, however, that the examples are for the purpose of illustration and are not to be construed as limiting the present invention.

1. Preparation of Electrolyte

Each electrolyte is prepared by dissolving Zn(CF₃SO₃)₂ at a concentration of 1 m in deionized water, and each additive according to Comparative Examples 1 to 5, Comparative Examples 6-1, 6-2, and Comparative Example 7, and Examples 1 to 2, Example 3-1, Example 3-2, Example 3-3, and Example 4 shown in Table 1 is added. In Table 1, the content of additives is the volume % content based on 100 volume % of the total amount of electrolyte and additives.

TABLE 1

| | | Donor | Content |
|---|---|---|---|
| | Additive | number | (volume %) |
| Comparative Example 1 | — | — | 0 |
| Comparative Example 2 | acetonitrile | 14.1 | 5 |
| Comparative Example 3 | ethanol | 19.2 | 5 |
| Comparative Example 4 | N,N-dimethyl | 26.6 | 5 |
| | formamide | | |
| Comparative Example 5 | 1,3-dimethyl-2- | 27.7 | 5 |
| | imidazolidinone | | |
| Comparative Example 6-1 | dimethyl sulfoxide | 29.8 | 5 |
| Comparative Example 6-2 | dimethyl sulfoxide | 29.8 | 20 |
| Comparative Example 7 | N,N- | 30.9 | 5 |
| | diethylformamide | | |
| Example 1 | pyridine | 33.1 | 5 |
| Example 2 | 2-methyl-1-propanol | 37 | 5 |
| Example 3-1 | Hexamethyl | 38.8 | 1 |
| | phosphoramide | | |
| Example 3-2 | Hexamethyl | 38.8 | 5 |
| | phosphoramide | | |
| Example 3-3 | Hexamethyl | 38.8 | 20 |
| | phosphoramide | | |
| Example 4 | 3-methylpyridine | 39 | 5 |

2. Manufacture of Zn/Zn Symmetric Cells

Each symmetrical cell is manufactured by using zinc metal foil (Goodfellow Corp.) as a positive electrode and a negative electrode, interposing a glass fiber separator having a thickness of 0.26 mm therebetween, inserting it into a battery case, and injecting the electrolytes of examples and comparative examples.

3. Manufacture of Full Cells

A full cell is manufactured, separately from the symmetric cell.

A positive electrode active material composition is prepared by mixing V₆O₁₃ powder, carbon black (Super-P), and polyvinylidene fluoride in a weight ratio of 7:2:1 in an N-methylpyrrolidone solvent as a positive electrode active material. The positive electrode active material composition is coated on a stainless steel foil in a loading amount of 4 mg/cm² and then dried to prepare a positive electrode. A zinc metal foil (Goodfellow Corp.) is prepared as a negative electrode.

After cutting the prepared positive and negative electrodes and inserting them into a battery case with a glass fiber separator having a thickness of 0.26 mm interposed therebetween, injecting the electrolytes of examples and comparative examples to manufacture each full cell.

### Evaluation Example 1: Surface Analysis of Negative Electrode

The Zn/Zn symmetric cells according to the examples and the comparative examples are repeatedly twice charged and discharged under constant current conditions of 1 mA/cm² and 1 mAh/cm² and once more discharged to perform 2.5 cycles in total and then, examined with respect to the surfaces of the negative electrodes.

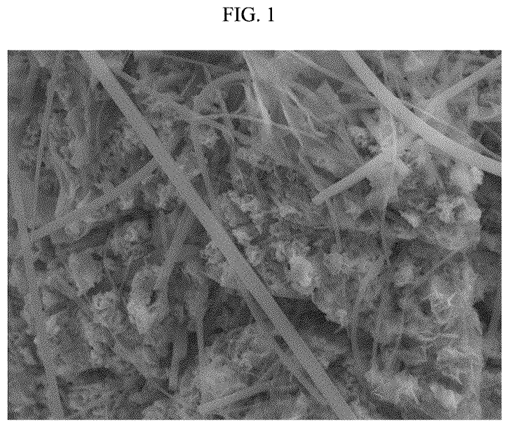

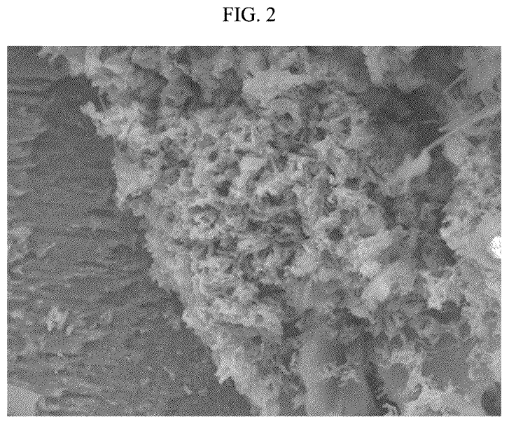

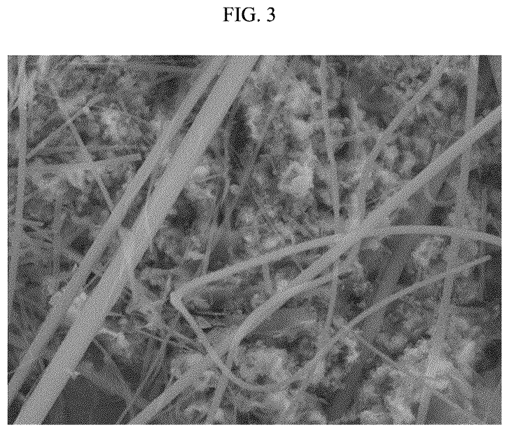

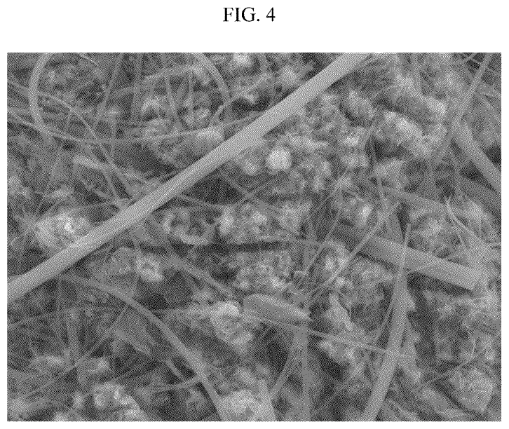

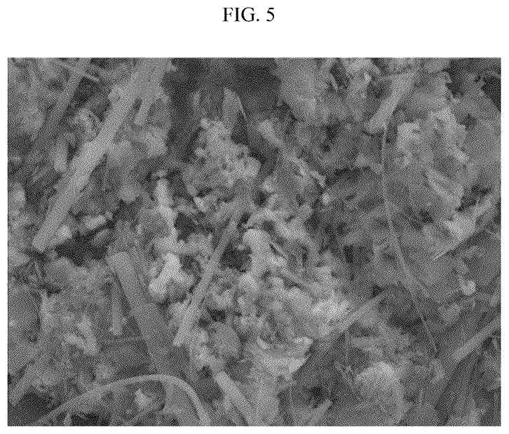

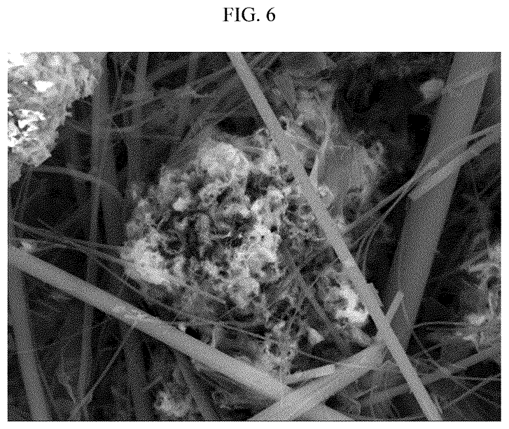

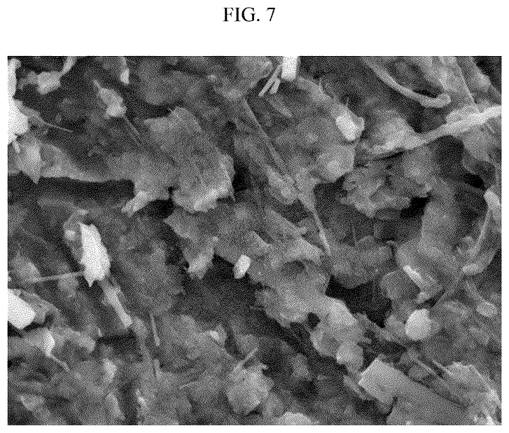

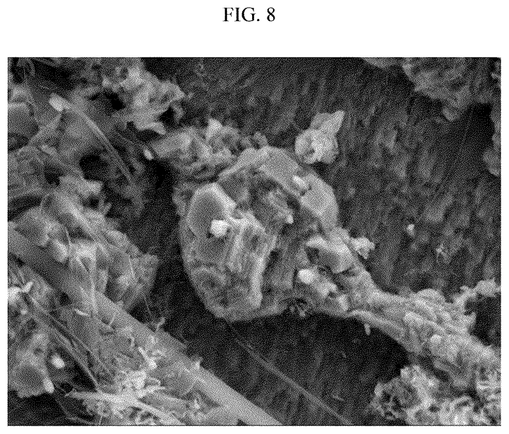

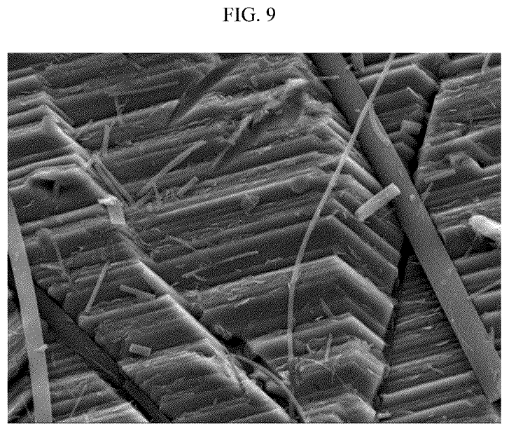

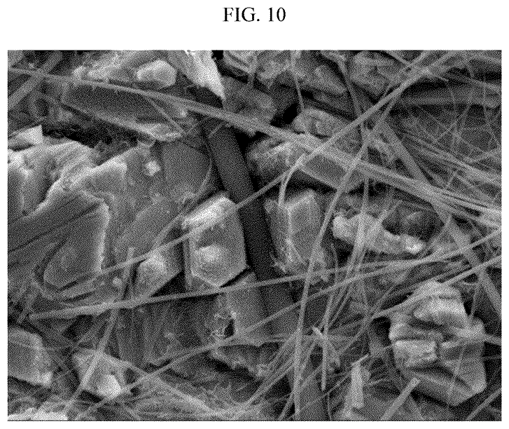

FIG. 1 is a SEM image of the surface of the negative electrode of Comparative Example 2, FIG. 2 is a SEM image of the surface of the negative electrode of Comparative Example 3, FIG. 3 is a SEM image of the surface of the negative electrode of Comparative Example 4, FIG. 4 is a SEM image of the surface of the negative electrode of Comparative Example 5, FIG. 5 is a SEM image of the surface of the negative electrode of Comparative Example 6-1, and FIG. 6 is a SEM image of the surface of the negative electrode of Comparative Example 7. FIG. 7 is a SEM image of the surface of the negative electrode of Example 1, FIG. 8 is a SEM image of the surface of the negative electrode of Example 2, FIG. 9 is a SEM image of the surface of the negative electrode of Example 3-2, and FIG. 10 is a SEM image of the surface of the negative electrode of Example 4. Comparing FIG. 1 with FIG. 10, the examples using a compound with the donor number of 32 or more as an additive exhibit changes of zinc electrodeposition modification and thus uniform electrodeposition without growth of zinc dendrites only on the surfaces of the negative electrodes of the examples shown in FIGS. 7 to 10, and particularly, Examples 2, 3-2, and 4 of FIGS. 8 to 10 exhibit electrodeposition modification of hexagonal column shape.

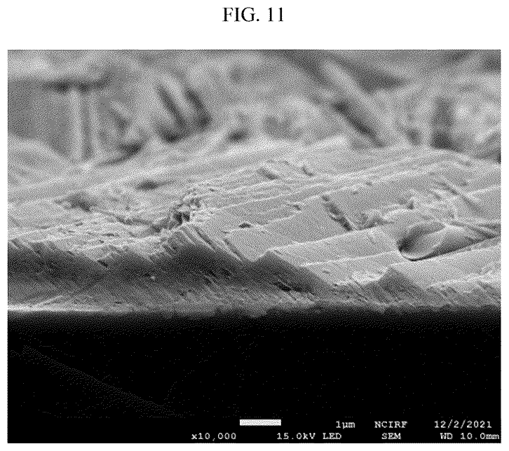

FIG. 11 is a SEM image of a cross-section of the negative electrode of Example 3-2, which confirms uniform electrodeposition and suppression of the dendrite growth.

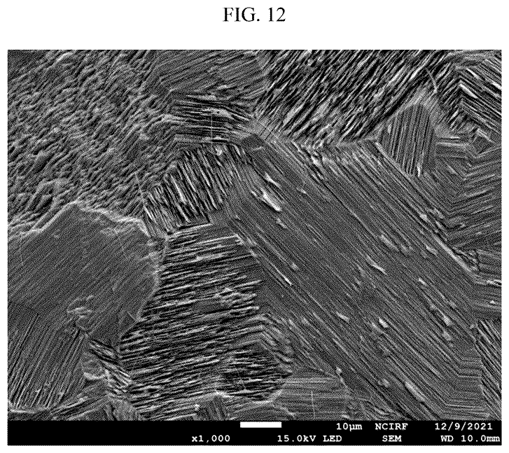

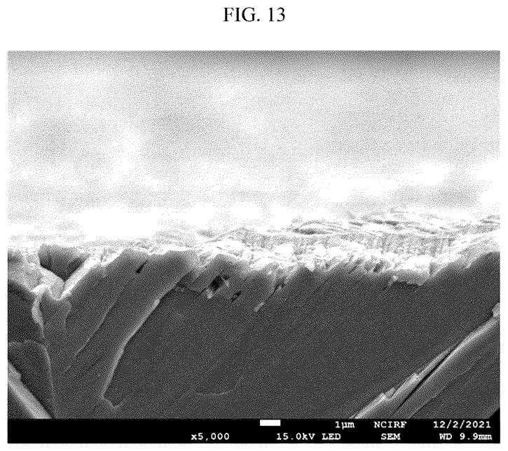

Subsequently, the symmetric cell of Example 3-2 is charged once more as the 3 rd cycle after the 2.5 cycles to examine the surface and cross-section of the negative electrode. FIG. 12 is a SEM photograph showing the surface of the negative electrode, and FIG. 13 is a SEM photograph showing the negative electrode cross-section. Referring to FIGS. 12 and 13, in the negative electrode, stripping of zinc also turns out to uniformly proceed, which confirms the suppression of the dendrite growth.

### Evaluation Example 2: Evaluation of Side Reactions of Water

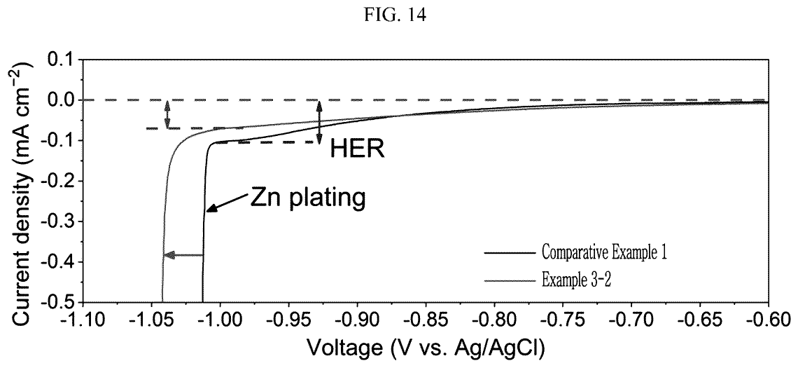

The cells using each electrolyte solution of Comparative Example 1 and Example 3-2 are measured with respect to current density according to a voltage through a linear sweep voltammetry (LSV) method, and the results are shown in FIG. 14. A 3-electrode Swagelok cell using a Ti foil as a working electrode, a Zn foil as a counter electrode, and Ag/AgCl as reference electrode and further using a glass fiber separator is used. A scanning is performed with an open circuit voltage (OCV) to −1.5 V at a scan rate of 0.2 mV/s.

A graph of FIG. 14 has a gentle slope at the beginning, where a hydrogen evolution reaction (HER) proceeds, while the scanning proceeds from a high voltage to a low voltage, but a sharp slope of a sharply-increasing current comes later, where a zinc electrodeposition takes place. Referring to FIG. 14, in Example 3-2, the voltage where zinc electrodeposition occurs due to an overvoltage by the additive is also pushed down (in a negative direction), but an amount (current density) of HER is also greatly reduced, resultantly confirming that a side reaction of water, that is, HER is suppressed.

### Evaluation Example 3: Evaluating Confirmation of Adsorption of Zinc Negative Electrode Interface of Additives

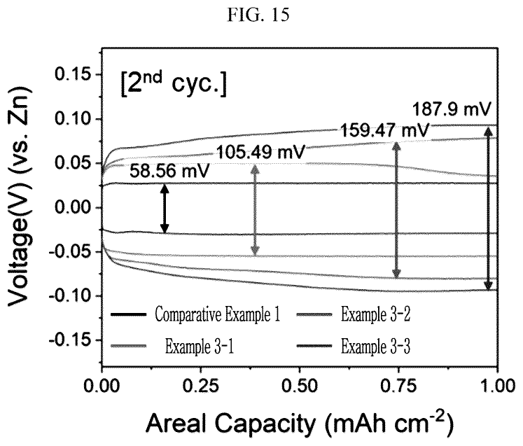

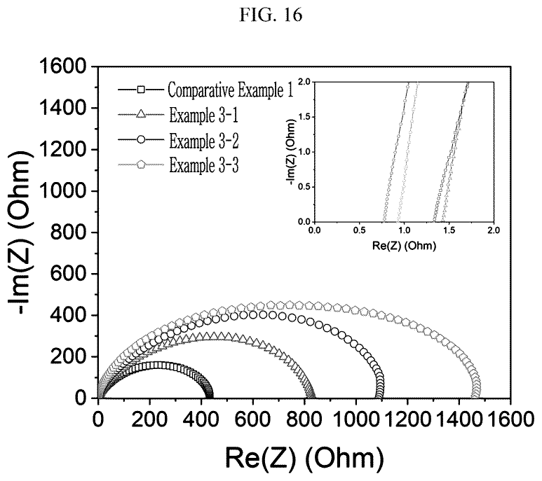

A galvanostatic charge-discharge (GCD) analysis of the symmetric cells of Comparative Example 1 and Examples 3-1, 3-2, and 3-3 is performed at the 2 nd cycle, and the results are shown in FIG. 15. In addition, an electrochemical impedance spectroscopy (EIS) analysis of the symmetric cells of Comparative Example 1 and Examples 3-1, 3-2, and 3-3 is performed, and the results are shown in FIG. 16.

Referring to FIGS. 15 and 16, compared with Comparative Example 1, the examples exhibit significantly increased overvoltage, that is, almost twice increased overvoltage with the addition of only 1 volume % of the additive according to an embodiment, which confirms that charge transfer resistance on the interface is increased. Accordingly, the additive according to an embodiment is understood to be adsorbed onto the interface of the zinc metal negative electrode and affect the interface. In addition, the additive of an embodiment is understood to have an effect of modifying the negative electrode interface with a small amount of 1 volume %.

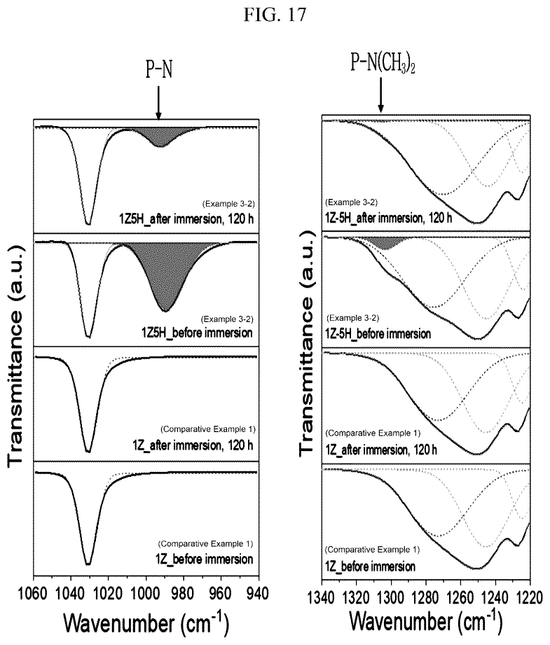

In order to additionally check whether or not the additive is adsorbed on the zinc metal negative electrode interface, zinc powder is impregnated in each electrolyte of Comparative Example 1 and Example 3-2 for 120 hours and then, analyzed with respect to the peak intensity of a specific functional groups of an adsorbate in a Fourier-transform infrared spectroscopy (FTIR) method, and the results are shown in FIG. 17.

FIG. 17 provides a top graph showing a transmittance after impregnating zinc powder in the electrolyte of Example 3-2 for 120 hours, a second graph from top showing a transmittance before impregnating zinc powder in the electrolyte of Example 3-2, a third graph from top showing a transmittance after impregnating zinc powder in the electrolyte of Comparative Example 1 for 120 hours, and a bottom graph showing a transmittance before impregnating zinc powder in the electrolyte of Comparative Example 1.

Referring to FIG. 17, Comparative Example 1 exhibits no wavelength change depending on whether or not the zinc powder is impregnated, but Example 3-2 exhibits that peak intensities corresponding to a P—N bond and a P—N(CH₃)₂ are reduced by impregnating the zinc powder. Accordingly, the additive of Example 3-2 is adsorbed in the zinc powder.

As a result, the additive according to an embodiment is adsorbed on the surface of the zinc metal negative electrode to modify the negative electrode interface and thereby, suppress a side reaction of water on the negative electrode interface, lead to uniform electrodeposition and stripping of zinc and suppress growth of zinc dendrites.

### Evaluation Example 4: Evaluation of Cycle-life Characteristics of Zinc Symmetrical Cell

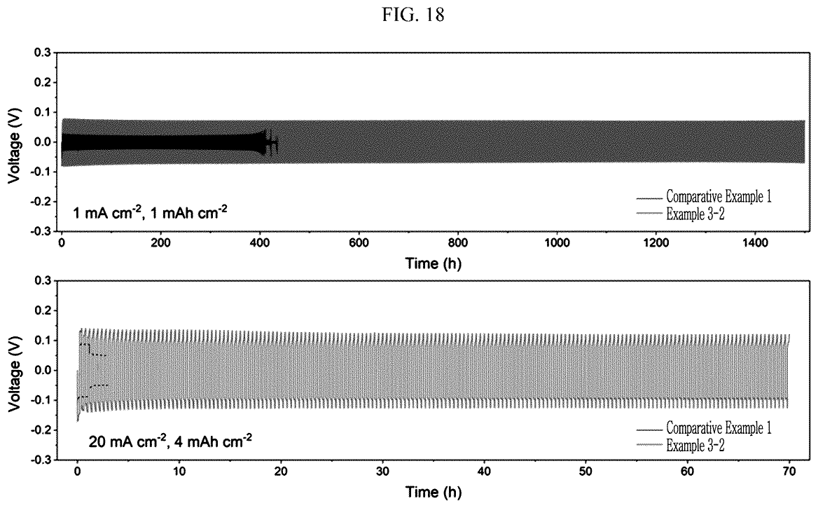

The Zn/Zn symmetric cells of Comparative Example 1 and Example 3-2 are repeatedly charged and discharged under constant current conditions of 1 mA/cm² and 1 mAh/cm² and then, measured with respect to a voltage change according to time to evaluate cycle-life characteristics, and the results are shown in a top graph of FIG. 18.

Separately, the Zn/Zn symmetric cells of Comparative Example 1 and Example 3-2 are repeatedly charged and discharged under conditions of 20 mA/cm² and 4 mAh/cm² and then, evaluated with respect to cycle-life characteristics, and the results are shown a bottom graph of FIG. 18.

Referring to FIG. 18, Example 3-2 using the additive according to an embodiment, compared with Comparative Example 1 including no additive, exhibits superbly excellent cycle-life characteristics.

### Evaluation Example 5: Evaluation of Cycle-Life Characteristics of Full Cells

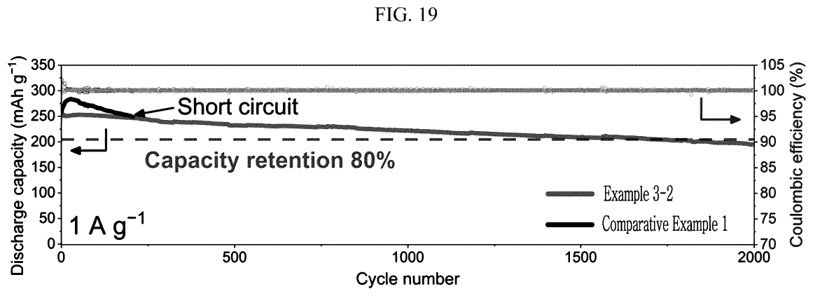

The full cells of Comparative Example 1 and Example 3-2 are repeatedly charged and discharged within a voltage range of 0.2 V to 1.5 V at a rate of 1 A/g and then, evaluated with respect to cycle-life characteristics, and the results are shown in FIG. 19. Referring to FIG. 19, the cell of Comparative Example 1 exhibits a short circuit before 250 cycles, but the cell of Example 3-2 exhibits capacity retention of 80% or more at 2000 cycles and thus less performance deterioration and realized very excellent cycle-life characteristics. In addition, the additive according to an embodiment turns out to improve battery performance by modifying the surface of the negative electrode without other side reactions or adverse effects in the cell to which a positive electrode such as vanadium oxide and the like is applied.

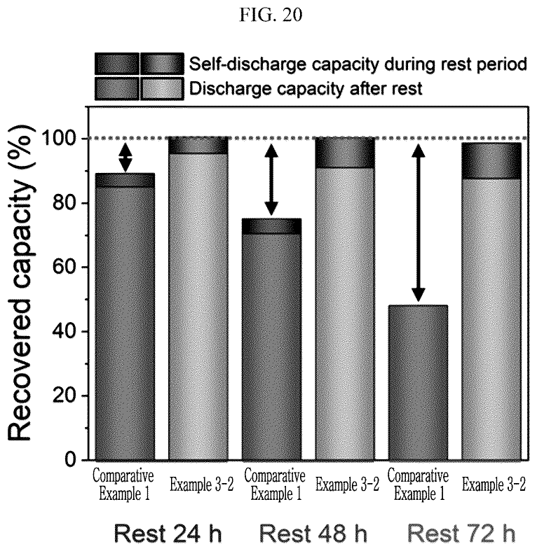

Furthermore, the full cells of Comparative Example 1 and Example 3-2 are compared with respect to irreversible capacity during a rest process, and the results are shown in FIG. 20. First, the cells end in a charge state after 30 cycles with 1 A/g and rested at an open circuit voltage (OCV) for a predetermined period of time, and a cycle proceeds again with 1 A/g. Herein, the rest proceeds as three sets of 24 hours, 48 hours, and 72 hours. Referring to FIG. 20, Comparative Example 1 generates irreversible capacity of about 10% due to the rest of 24 hours, irreversible capacity of about 25% due to the rest of 48 hours, and irreversible capacity of about 50% due to the rest of 72 hours, but Example 3-2 exhibits irreversible capacity of less than 1%. Accordingly, when the additive according to an embodiment is used, the problem of generating irreversible capacity during the non-operating time during the cycles is effectively suppressed.

### Evaluation Example 6: Comparison of Cycle-Life Characteristics of Full Cells

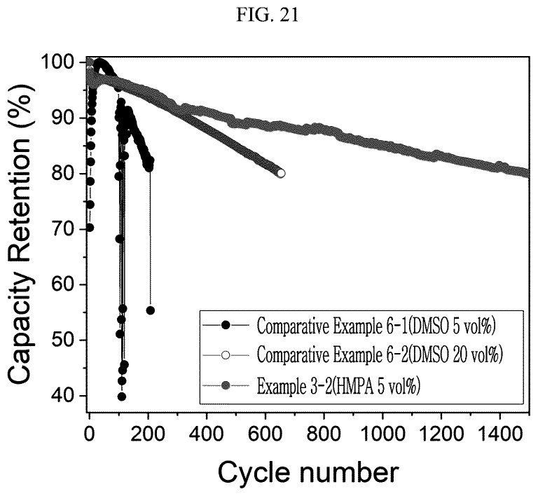

The full cells of Example 3-2 and Comparative Examples 6-1 and 6-2 are repeatedly charged and discharged within a voltage range of 0.2 V to 1.5 V at a rate of 1 A/g and then, evaluated with respect to cycle-life characteristics, and the results are shown in FIG. 21. Referring to FIG. 21, Comparative Example 6-1 using 5 volume % of dimethyl sulfoxide (DMSO) with the donor number of 29.8 exhibits sharply deteriorated capacity retention before 200 cycles, Comparative Example 6-2 using 20 volume % of the dimethyl sulfoxide (DMSO) exhibits capacity retention of 80% or less at 600 cycles, and Example 3-2 using 5 volume % of hexamethylphosphoramide (HMPA) with the donor number of 38.8 exhibits capacity retention of 80% or more even at 1400 cycles, which is twice or more better cycle-life characteristics than the case of using 20 volume % of DMSO.

After all, when a compound having the donor number of about 32 or more as an additive is used according to an embodiment, this additive is absorbed onto the surface of the zinc metal negative electrode to modify the interface and thereby, suppress a side reaction of water and lead to uniform electrodeposition/stripping of zinc but suppress growth of zinc dendrites, resulting in improving battery performance such as cycle-life characteristics and the like.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A zinc rechargeable battery, comprising
a positive electrode,
a zinc-containing negative electrode,
a separator between the positive electrode and the negative electrode, and
an electrolyte,
wherein the zinc rechargeable battery includes an additive, and
the additive is a compound having a donor number of about 32 or more.

2. The zinc rechargeable battery of claim 1, wherein
the additive is present on the surface of the negative electrode and/or in the electrolyte.

3. The zinc rechargeable battery of claim 1, wherein
the compound having a donor number of about 32 or more includes an element containing an unshared electron pair and a hydrophobic functional group.

4. The zinc rechargeable battery of claim 3, wherein
the element containing an unshared electron pair is N, O, P, or S, and
the hydrophobic functional group is a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, or a combination thereof.

5. The zinc rechargeable battery of claim 1, wherein
the compound having a donor number of about 32 or more is a substituted or unsubstituted pyridine, a branched chain alcohol, a substituted or unsubstituted phosphoramide or a derivative thereof, a substituted or unsubstituted thiophosphoramide or a derivative thereof, or a combination thereof.

6. The zinc rechargeable battery of claim 1, wherein
the compound having a donor number of about 32 or more is at least one of the compounds represented by Chemical Formulas 1 to 3: 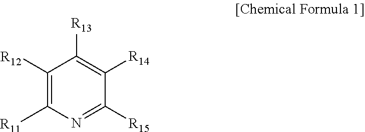
wherein, in Chemical Formula 1 R₁₁ to R₁₅ are the same or different and are each independently hydrogen, a halogen element, a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, or a combination thereof, 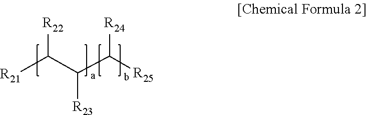
wherein, in Chemical Formula 2, R₂₃ is a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, a hydroxy group, or a combination thereof, R₂₁, R₂₂, R₂₄, and R₂₅ are the same or different and are each independently hydrogen, a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, a hydroxy group, or a combination thereof, and at least one of R₂₁ to R₂₅ is a hydroxy group, and a and b are each integers of 1 to 10, 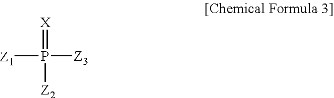
wherein, in Chemical Formula 3, X is O or S; Z₁ is NR₃₁R₃₂, OR₃₃, or Cl; Z₂ is NR₃₄R₃₅, OR₃₆, or Cl; Z₃ is NR₃₇R₃₈, OR₃₉, or Cl, at least one of Z₁, Z₂, and Z₃ is an amine group; and R₃₁ to R₃₉ are each independently hydrogen, a substituted or unsubstituted alkyl group having 1 to 20 carbon atoms, a substituted or unsubstituted cycloalkyl group having 3 to 20 carbon atoms, a substituted or unsubstituted aryl group having 3 to 20 carbon atoms, or a combination thereof.

7. The zinc rechargeable battery of claim 1, wherein
the compound having a donor number of about 32 or more is pyridine, alkyl-substituted pyridine, branched-chain aliphatic alcohol, alkyl-substituted phosphoramide, alkyl-substituted thiophosphoramide, or a combination thereof.

8. The zinc rechargeable battery of claim 1, wherein
the compound having a donor number of about 32 or more has a donor number of about 37 or more.

9. The zinc rechargeable battery of claim 1, wherein
the additive is included in an amount of about 0.1 volume % to about 60 volume % based on 100 volume % of a total amount of the electrolyte and additive.

10. The zinc rechargeable battery of claim 1, wherein
the additive is included in an amount of about 0.1 volume % to about 20 volume % based on 100 volume % of the electrolyte.

11. The zinc rechargeable battery of claim 1, wherein
the electrolyte is an aqueous electrolyte or a mixture of aqueous and organic electrolytes.

12. The zinc rechargeable battery of claim 1, wherein
the electrolyte includes a zinc salt at a concentration of about 0.1 m to about 30 m.

13. The zinc rechargeable battery of claim 1, wherein
the electrolyte includes a zinc salt, and
the zinc salt includes ZnSO₄, Zn(NO₃)₂, Zn(CH₃CO₂)₂, ZnCl₂, ZnBr₂, Zn[N(CF₃SO₂)₂]₂, a hydrate thereof, or a combination thereof.

14. The zinc rechargeable battery of claim 1, wherein
the positive electrode includes an inorganic positive electrode active material, an organic positive electrode active material, or a combination thereof.

15. The zinc rechargeable battery of claim 14, wherein
the inorganic positive electrode active material includes a metal oxide, and the metal is at least one selected from Co, Ni, Mn, V, and Zn.

16. The zinc rechargeable battery of claim 1, wherein
the negative electrode includes a negative electrode active material including zinc metal, a zinc alloy, or a combination thereof,
the zinc alloy includes at least one element selected from Ag, Al, Au, B, Ba, Ca, Ce, Co, Cr, Cu, F, Fe, Hg, In, Mg, Mn, Ni, P, S, Si, Sn, Sr, Ti, V, W, and Zr and zinc.
